(19) United States
(12) Patent Application Publication
(10) Pub. No.: US 2003/0167875 A1
(43) Pub. Date: Sep. 11, 2003

(54) Device for damping oscillations

(76) Inventors: Gregor Polifke, Giengen (DE); Armin Hartleitner, Ziertheim (DE); Rolf Brockmann, Heidenheim (DE)

Correspondence Address: BAKER & DANIELS, 111 E. WAYNE STREET, SUITE 800, FORT WAYNE, IN, 46802

(21) Appl. No.: 10/342,131

(22) Filed: Jan. 14, 2003

(30) Foreign Application Priority Data
Jan. 15, 2002 (DE) 102 01 252.0

(51) Int. Cl. F16F 15/10

(52) U.S. Cl. 74/574

(57) ABSTRACT

The invention relates to a device for damping oscillations, especially an oscillation damper

having a primary unit and a secondary unit which can be rotated relative to each other in the circumferential direction by a restricted amount;

the primary unit forms an inner chamber in which the secondary unit is disposed;

the primary unit and the secondary unit are connected via a spring coupling and a damping coupling;

the damping coupling comprises at least one damping chamber that can be filled with a damping medium;

in the inner chamber there is disposed at least one ring-shaped unit which is not connected in a form-locking manner with the primary unit and the secondary unit;

having a contactless sealing device between the ring-shaped element and the primary unit;

the ring-shaped unit forms first damping chambers with the primary unit and second damping chambers with the secondary unit;

The invention is characterized by

at least one dynamic contact sealing device for at least partially sealing the first damping chambers in an axial and/or radial direction.

The invention relates to a device for damping oscillations, more particularly having the characteristics of the characterizing portion of claim 1.

Devices for damping oscillations are known in various embodiments. For example, reference is made to the following documents:

1. DE 39 23 749

2. DE 198 30 208

Said devices can be configured as a resilient coupling for torque transmission in a drive train between the driving side and the output drive, whereby an additional damping effect is achieved because of the resilience. They can also be used as a quencher, which means a device used for reducing oscillations occurring in the drive train, especially in rotating components, not for damping oscillations in the torque transmission between two components of the drive train. The basic structure of the two devices is generally the same. They comprise a primary unit coupled with a driving side so as to be rotation-proof and a secondary unit. The only deciding factor for the function as a resilient coupling or as a quencher is whether a rotation-proof coupling exists between the secondary unit and the output drive. The primary unit and the secondary unit are connected via a damping and spring coupling. The term spring coupling is used generally for coupling by means of resilient elements. The damping coupling can function either by means of the spring elements or hydraulically. Especially in the embodiments using hydraulic damping the damping effect is based on the displacement of damping medium in so-called damping or displacement chambers. From the document DE 39 23 749 C1 a device for damping oscillations is known having the form of a resilient coupling in disc style where the primary unit is the first coupling half encompassing the secondary unit, which is the second coupling half, by means of two lateral discs connected so as to be torsion-proof on the outside circumference. The second coupling half is formed by at least one disc associated with a hub. The two coupling halves are connected by means of resilient coupling elements and can be rotated by a restricted amount relative to each other in the circumferential direction. The lateral discs of the primary unit delimit a fluid-tight inner chamber which houses the central disc and which is filled with a damping medium. In the radially outer region of the inner chamber located between the lateral discs there is at least one displacement chamber whose volume is variable when the coupling halves are rotated and which can be filled with the damping medium. In the inner chamber, there is disposed a suspended damping ring which can be rotated by a restricted amount relative to each of the two coupling halves and which is not connected in a form-locking manner with the primary and secondary unit. Said ring forms at least a first displacement chamber with the primary unit, i.e. the first coupling half, and at least a second displacement chamber with the secondary unit, i.e. the second coupling half. Having two displacement chambers separated in such a way is advantageous in that the coupling can respond automatically to the torsional oscillations with a damping dependent on the amplitudes of oscillation and it also has better running properties during change of load operations.

An oscillation quencher is known from the document DE 198 30 208. It is used for quenching oscillations and is not involved in the torque transmission.

Such embodiments are frequently installed in vehicle transmissions where modular units are also conceivable in connection with automatic transmissions. Such an embodiment of a modular unit consisting of starting element, bridging coupling with an integrated hydraulic oscillation damper in the form of a resilient coupling is found in the document WO 01/11267.

Usually, such integrated units are operated with the transmission oil as damping medium. This means that only one supply system is used for the operating medium and no other media have to be provided in the transmission. Moreover, such dampers can also be configured open so as to run directly in the transmission oil. However, this results in inferior damping properties. Especially the desired damping level compared to traditional grease-filled dampers was not achieved and results in a negative effect on the entire transmission behavior and thus on the driving comfort.

Therefore, the object of the invention is to provide a device for damping oscillations which is suitable for optimal operation with transmission oil in a configuration as an open oscillation dampener and integrated in a transmission unit. The inventive solution should be characterized by minor additional structural and technical production efforts.

The solution of the invention is characterized by the features of claim 1. Advantageous embodiments are described in the sub-claims.

The device for damping oscillations comprises a primary unit and a secondary unit which can be rotated relative to each other by a restricted amount in the circumferential direction. The primary unit and the secondary unit are coupled via a spring coupling and a damping coupling. The terms primary unit and secondary unit define a functional unit consisting of one component or a plurality of elements or components forming said unit. The primary unit at least partially encompasses the secondary unit in a radial and axial direction and delimits an inner chamber that houses a portion of the secondary unit and which can be filled with a damping medium. In one area of the inner chamber, preferably in the radially outer area, there is at least one damping chamber whose volume is variable by means of rotating the primary unit and the secondary unit and which can be filled with the damping medium. According to the invention, the displacement chamber is configured so as to be at least partially pressure-medium-tight in an axial and/or radial direction by means of dynamic contact seals.

According to an especially advantageous embodiment, a ring-shaped unit is provided in the inner chamber, which unit can be rotated by a restricted amount relative to the primary unit or the secondary unit. Said unit forms first damping or displacement chambers with the primary unit and second damping or displacement chambers with the secondary unit. Moreover, means for limiting the torsion angle are provided comprising on one of the units (primary unit or secondary unit) stationary stopping elements forming at least one stop in the circumferential direction. The stopping elements are disposed in one of the two damping or displacement chambers and divide said chamber into two partial damping chambers which are variable in size. Preferably, the damping or displacement chamber which is divided into varying partial damping chambers is configured so as to be at least partially pressure-medium-tight in an axial and/or radial direction by means of at least one dynamic contact seal.

It was found that the low viscosity of the transmission oils in connection with the production-related minimum width of the gaps between the individual elements forming a damping chamber is responsible for the inferior damping properties. More particularly, the suspended damping ring or the individual segments are generally guided in respective guides in the primary unit. The damping ring or an individual segment, respectively, and the guide then form a labyrinth seal. This is achieved in that on the damping ring or the individual ring segments as viewed in an axial direction guide rails are disposed running in the circumferential direction. In unloaded condition, i.e. when no damping operation is required, the guide rails with the guides on the primary unit form gaps. The guide rail is in the center of the gap. Relative to the remaining housing, there are also gaps in an axial and radial direction. Only during damping operations, the damping medium pushes the segment radially inward so that the radially inner gap is closed by positioning the guide rail in the guide groove. However, the radially outer gap between the primary unit and the damping ring or the ring segment, respectively, then increases as does the radial gap between the stop and the damping ring or the ring segment. The exchange of damping medium then usually takes place via said gap. With oils of low viscosity, especially the so-called ATF oils with a kinematic viscosity in the range from including 10 to 70 cSt, preferably from including 40 to 60 cST, it is often not possible to close the labyrinth gap, and therefore the oil escapes not only in a radial direction via the gap between the primary unit and the damping ring or ring segment, but also in an axial direction between the primary unit and the damping ring or ring segment. The available damping volume can then no longer be fully utilized.

Therefore, according to the invention, in order to improve the utilization of the theoretic damping volume, which is available in any case, while maintaining the advantageous non-wearing hydraulic damping, an at least partially pressure-medium-tight configuration of the damping chamber is selected by providing dynamic contact seals disposed between elements moving relative to each other. Said elements are preferably configured such that in unloaded condition at least a partial seal is already achieved between the elements moving relative to each other. Additionally, it can be configured such that the hydraulic sealing effect is intensified by the application of force.

The above solution is advantageous in that with a minor modification a device for damping oscillations of the above described type can be developed for use as an open dampener in transmission units while utilizing the operating or control medium, which is available in the transmission unit in any case, as damping medium, where the principal means of damping remains the especially advantageous non-wearing hydraulic damping.

The dynamic contact seal is preferably a lip seal comprising only the sealing lip or a seal carrier with a sealing lip. The dynamic contact seal is resilient and the resilience of the complete unit, sealing lip and optionally a seal carrier is dependent upon the choice of material and/or the configuration, i.e. form and geometric dimensions of the individual elements of the sealing device. Preferably, materials and configurations are selected for the lips which are characterized by high sealing and low friction behavior. The friction behavior can be characterized as a function of material-specific and process-specific values, such as the hardness and surface quality of the seal, and in the cooperation with the elements that move or are being moved relative to the seal, by the material-specific und process-specific values of said elements. The sealing lips or the complete unit consisting of the sealing lip and elements carrying the sealing lip are preferably made of plastic.

Ring-shaped unit should be understood to mean the elements assuming the function of the suspended damping ring. Said unit can comprise a ring-shaped element which is provided with projections or cams in the circumferential direction in a radial direction on the outside circumference delimiting the first damping or displacement chambers. Two successive projections or cams in the circumferential direction with their facing surfaces and the surface on the primary unit pointing inward in a radial direction and the surface on the ring-shaped element pointing radially outward facing the primary unit, i.e. the outside circumference delimit one of the first damping or displacement chambers. In a radial direction on the inside circumference, projections or cams can also be provided which engage in respective recesses in the secondary unit,

where said cams with the secondary unit or the outside circumference of the secondary unit, respectively, delimit the second displacement chambers. In this case, two cams disposed successively or adjacent in the circumferential direction also delimit a second damping or displacement chamber. Alternatively, the recesses can also be provided on the inside circumference of the ring-shaped element, while the projections are provided on the secondary unit.

According to another embodiment of the ring-shaped unit, said unit comprises in the circumferential direction a plurality of individual ring segments disposed successively in the circumferential direction, which are not connected and merely form the functional unit of the ring-shaped unit. Said ring segments are then configured such that they also have cams or projections at their respective end regions in the circumferential direction, where the outer surface of the cams in radial direction is preferably substantially parallel with the inside surface of the primary unit, and thus forming a sealing surface of a contactless seal. Therefore, viewed in cross-section in the circumferential direction, the cams are substantially L-shaped, where said cams with their inside surface in assembled position delimit the second displacement chamber which is also delimited by cams on the secondary unit.

Sealing the displacement chambers between the primary unit and the ring-shaped unit can be achieved by means of the following measures, which can also be combined:

1. fully sealing the displacement chamber

2. partially sealing the displacement chamber

in an axial and/or radial direction.

According to an especially advantageous embodiment, the displacement chamber is fully sealed so as to fully utilize the damping volume which is theoretically available.

Said seal is achieved by providing sealing measures on the individual ring segments of the ring-shaped unit or on the entire ring-shaped unit. For embodiments that include ring segments, each individual ring segment is provided with a respective dynamic contact sealing device, which can be disposed

a) either continuously on the radially oriented surface of the ring segment, or

b) on the end faces oriented in an axial direction with a transition via the surfaces on the cam pointing in a radial direction to the inside of the primary unit.

According to another embodiment, the dynamic contact seal can also be discontinuous. In this case, the damping behavior can be progressive.

The lip and/or the element carrying the lip are preferably resilient so as to also rest in an axial direction on the adjacent elements under pressure. In this case, a fully encapsulated first displacement chamber can be realized. When said ring-shaped unit is configured as a damping ring the arrangement is analog on each of the individual displacement chambers. This means that a plurality of such sealing devices is provided based on the number of displacement chambers.

According to another embodiment, where only a partial seal is required, the sealing device is disposed on the stop. Again, said sealing device, as viewed in assembled position, can be complete or partial over the circumference in an axial direction of the stopping element. If provided only on the axial end faces, there is a seal only in an axial direction; with additional sealing on the surfaces in a radial direction, there is a seal in a radial direction as well.

The dynamic contact seal runs at least partially over the outside circumference of the stop in an axial and radial direction. For the embodiments of the stop consisting of two partial elements, a first stationary partial element mounted on the primary unit and a second partial element which can be moved in the circumferential direction provided in the primary unit, the dynamic contact seal can be disposed on one of the two partial elements. Moreover, it is possible to assemble the stop or one of the partial elements of the stop from multiple parts connected in a force-locking or form-locking manner, where the sealing device is configured as a profiled seal braced between the separate parts.

Under an especially advantageous aspect of the invention, the geometry on the projections or cams can be used so as to achieve a sealing effect, regardless of whether or not said effect is based on providing or mounting sealing devices on said projections. The projections on the ring segment or the damping ring as seen in cross-section from top in assembled position can be configured with two axial projections oriented toward the stop or the secondary unit in the circumferential direction. The surfaces on the projections formed in an axial direction and facing each other are then wedge-shaped. According to the invention, an additional sealing effect can now be achieved in that in the final stop position of the ring segment or the respective cam, the pulling cam of the secondary unit or the stop rests against the ring segment cam. If one of the two cam surfaces is wedge-shaped, for example a surface of the cam oriented in an axial direction, the sealing surfaces of the ring segment in the area of the ring segment cam are pushed against the housing or cover contour which increases the hydraulic sealing effect. Additionally or alternatively, the leading surfaces for the final stop position can be configured in a complimentary manner so as to achieve a sealing effect on the stop or on the secondary unit.

In all embodiments, based on the choice of material for the segments, the ring-shaped element or the stop element, if the seal on the element consists of the same material it can be configured so as to form one unit with said element. According to another option the elements carrying the seals and the seal consisting of the same material are coupled, but with a form-locking connection. The third option is to manufacture the elements carrying the seal and the seal from different materials and to couple them in a form-locking and/or force-locking manner.

The solution of the invention is explained below by means of the drawings, more particularly showing the following:

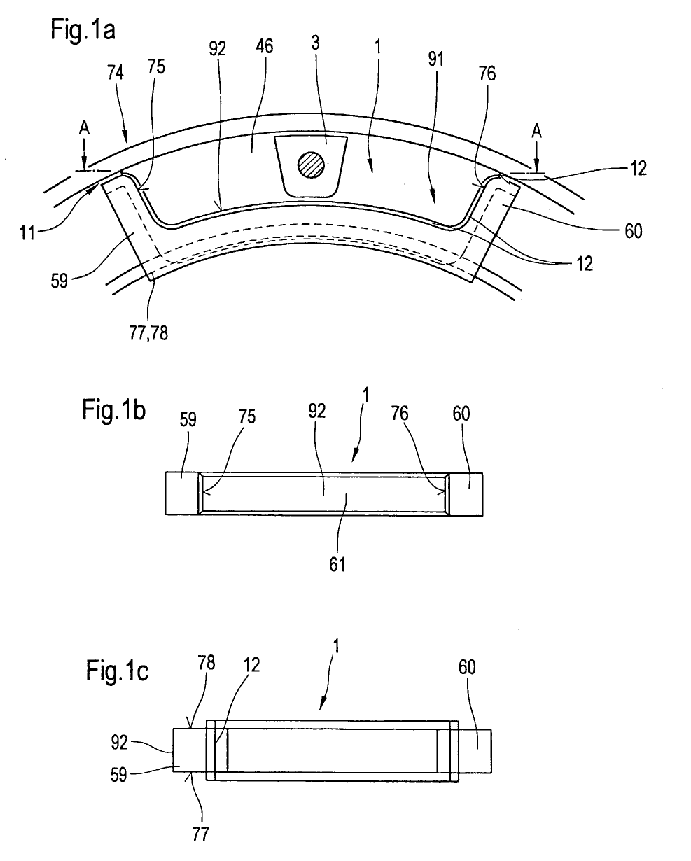

FIGS. 1a and 1b: illustrate by means of two views an arrangement of the invention of a continuous flexible sealing lip on a ring segment;

FIG. 1c: illustrates by means of a view according to FIG. 1b an alternative arrangement of a continuous sealing lip on the ring segment;

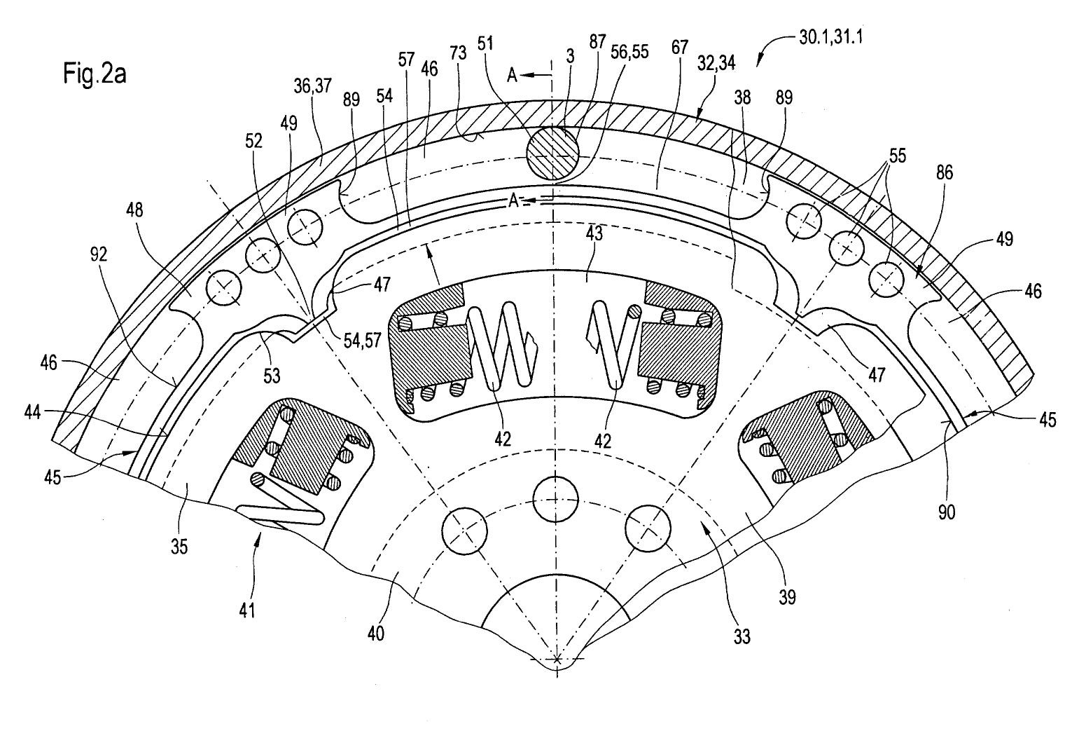

FIGS. 2a and 2b: show by means of two sectional views vertical relative to the axial plane potential embodiments of damping chambers according to prior art;

FIGS. 2c to 2e: illustrate the sealing situation by means of two views for the embodiments shown in FIGS. 2a and 2b;

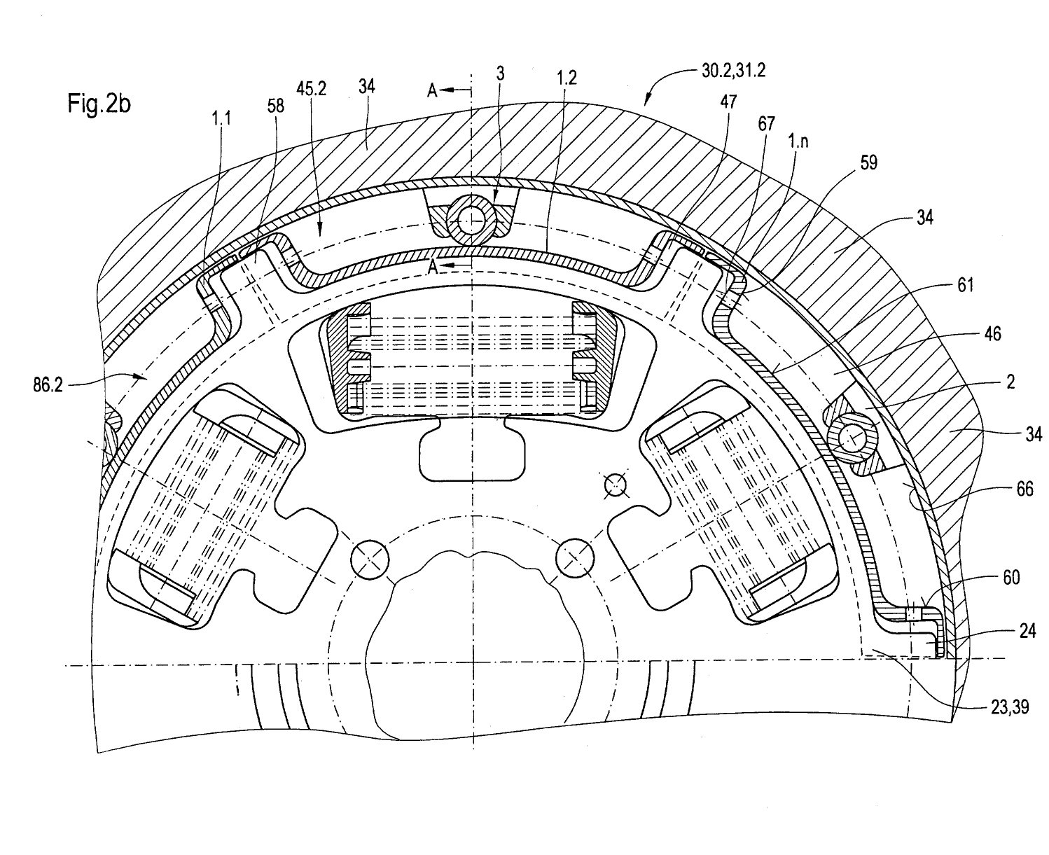

FIGS. 3a and 3b: show an embodiment of a ring segment with a bridge in two views:

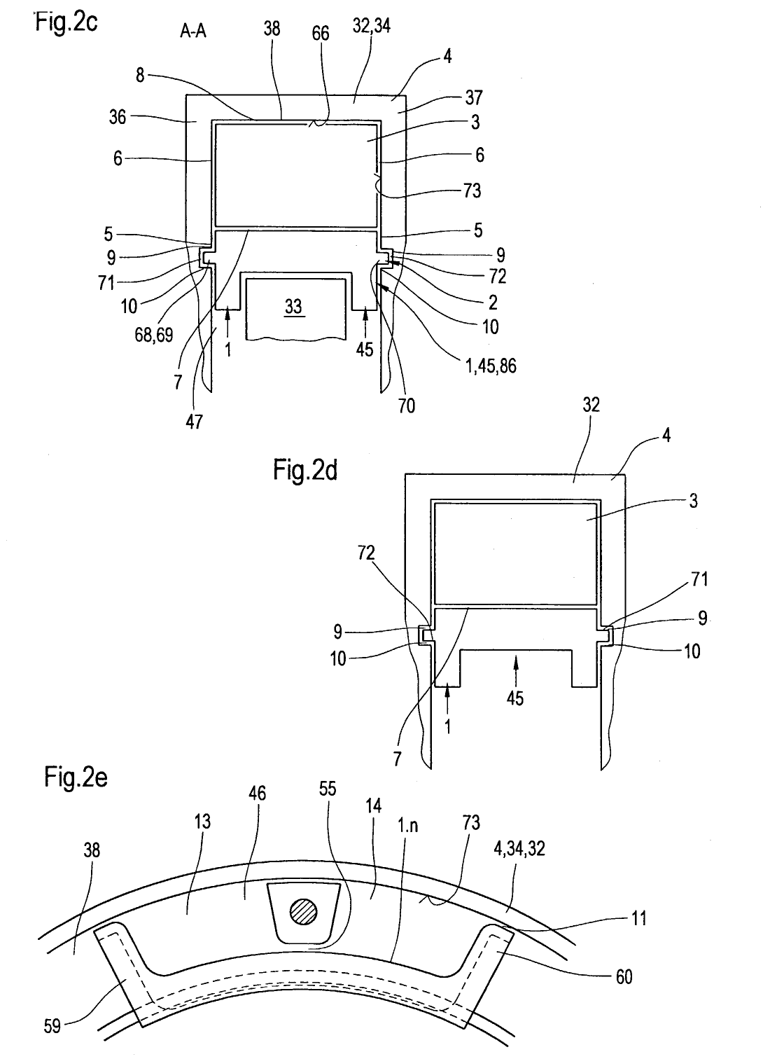

FIGS. 4a and 4b: each illustrate a modification of an embodiment according to FIGS. 1a and 3a in a sectional plane extending in the circumferential direction through a device for damping oscillations with the sealing lips disposed in the center;

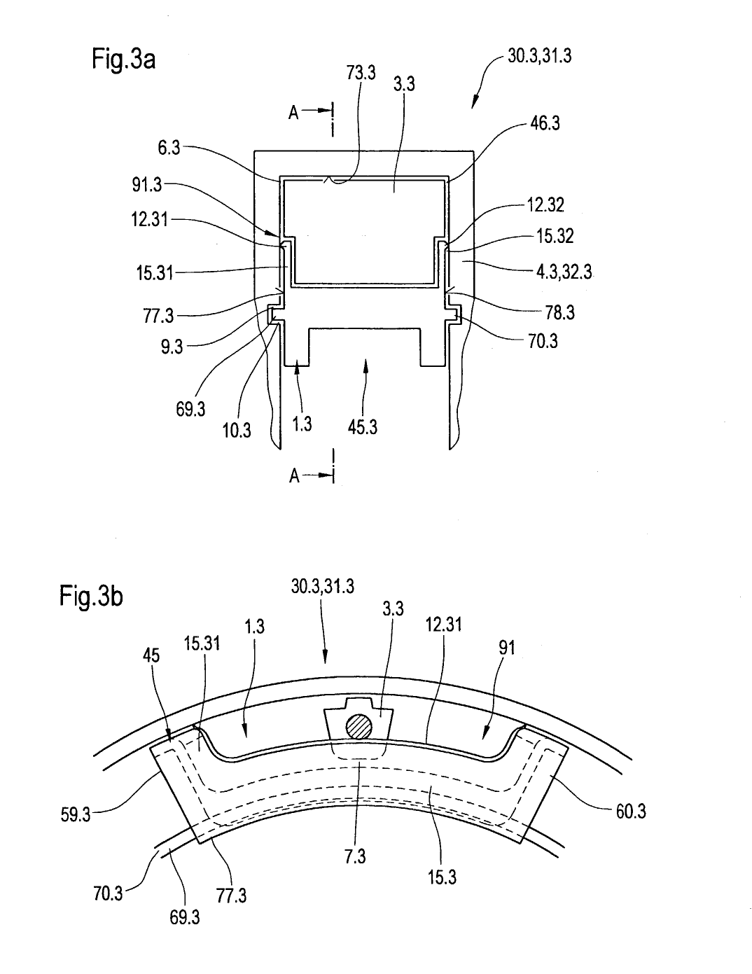

FIGS. 5a and 5b: illustrate embodiments of stop elements in accordance with prior art;

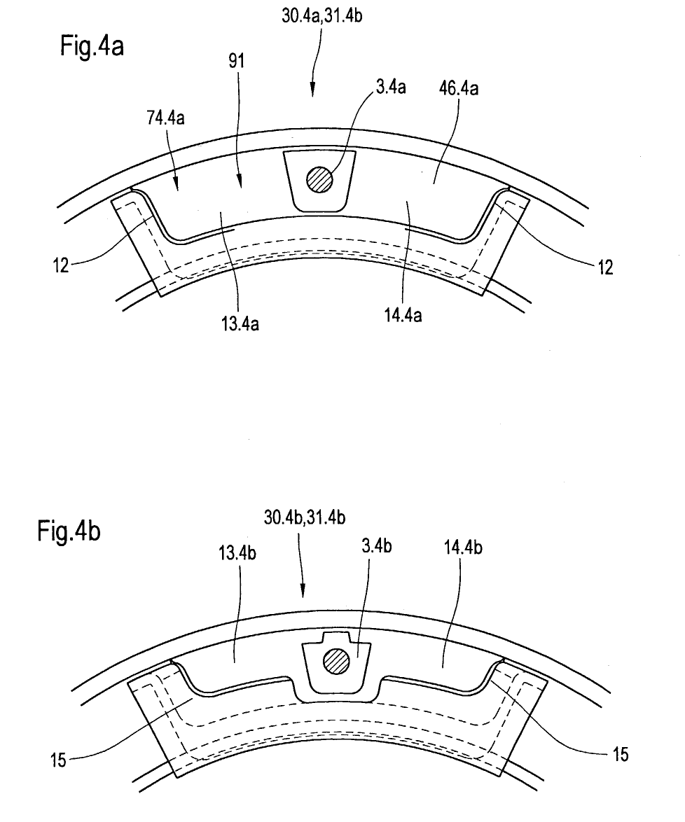

FIGS. 6a and 6b: show potential configurations according to the invention of the arrangement of a sealing lip on the circumference of a stop;

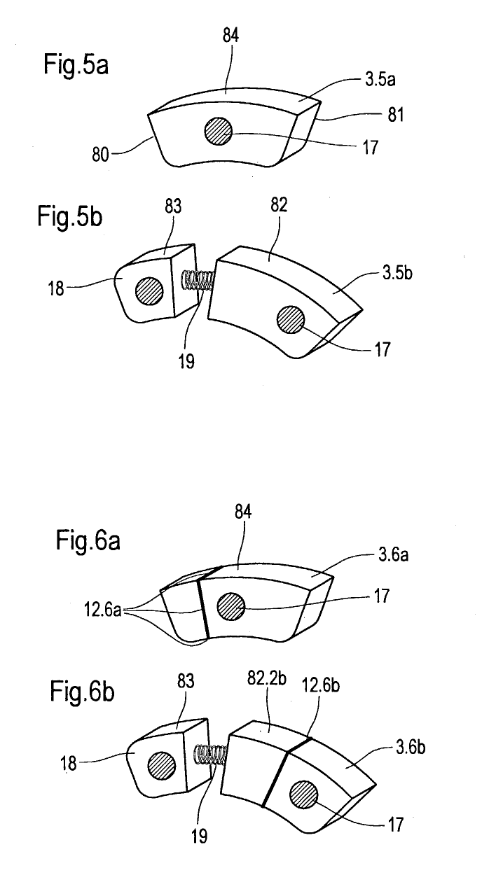

FIGS. 7a to 7c: show multi-part stop configurations according to FIGS. 6a and 6b with intermediate seals;

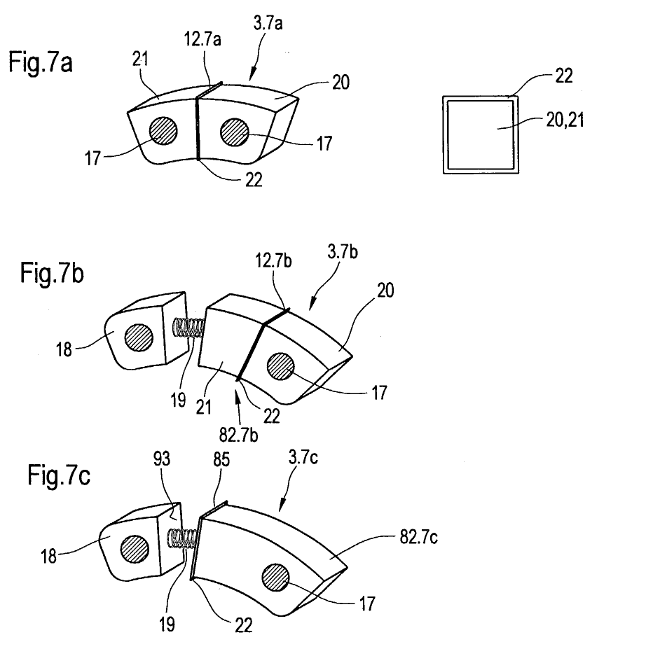

FIG. 8a: illustrates by means of a top view the configuration of a cam on the ring segment for encompassing the pulling element on the secondary unit;

FIGS. 8b and 8c: illustrate an advantageous wedge-shaped configuration of the areas of contact on the cam of the ring segment in unloaded and loaded condition, i.e. when the pulling cam is in the stop position on the secondary unit;

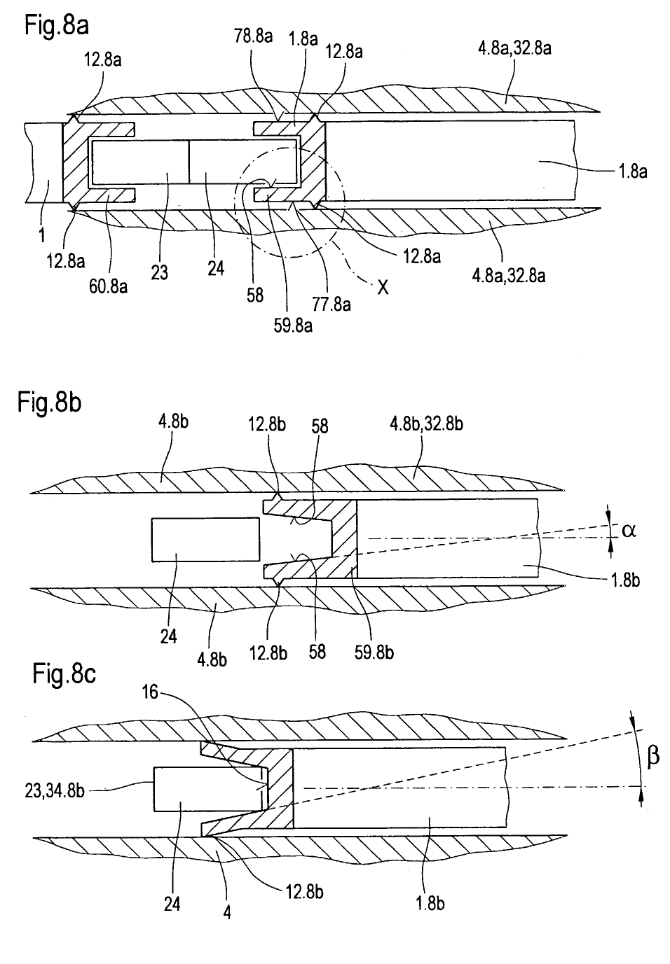

FIG. 9: shows a plurality of various configurations of the wedge-shaped area of contact on the cam of the ring segment by means of a section of a cross-sectional view of the cam as seen from top;

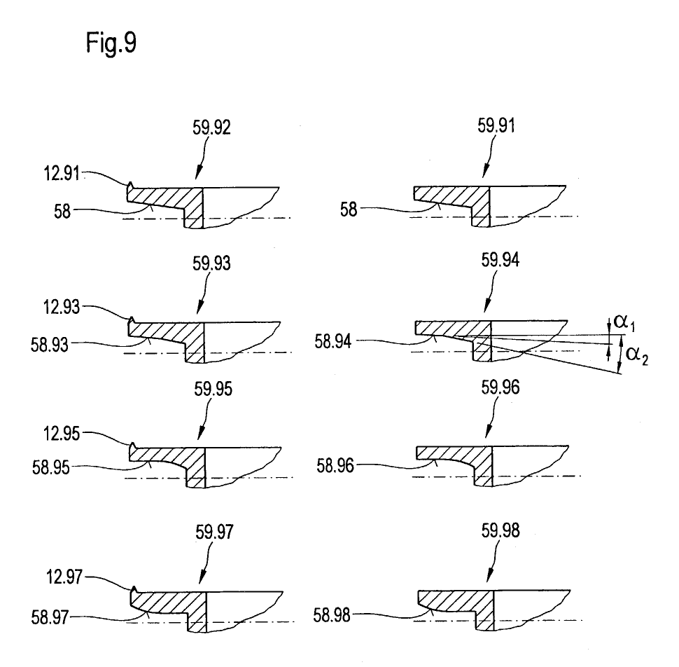

FIG. 10: illustrates a plurality of potential configurations of the leading surfaces on the pulling cams of the secondary unit;

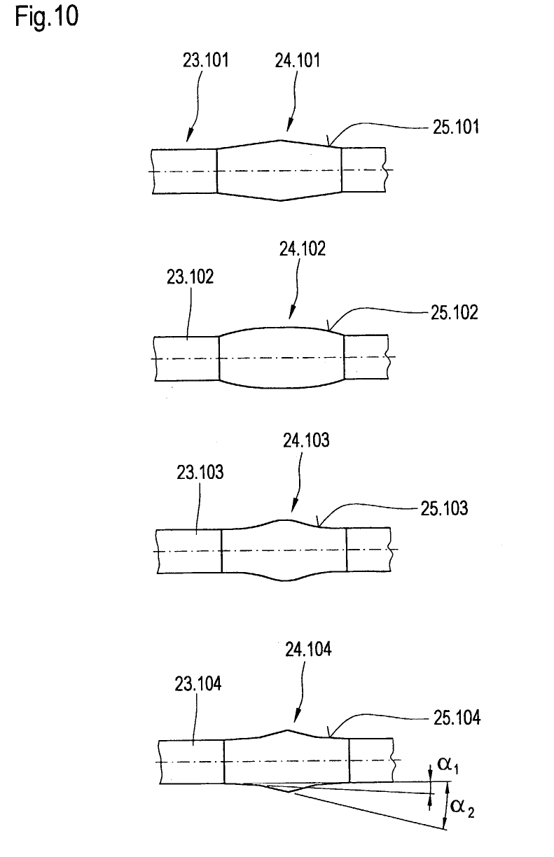

FIG. 11: illustrates potential configurations of the cams on the ring segment in the area of the end face delimiting the damping or displacement chamber in the circumferential direction;

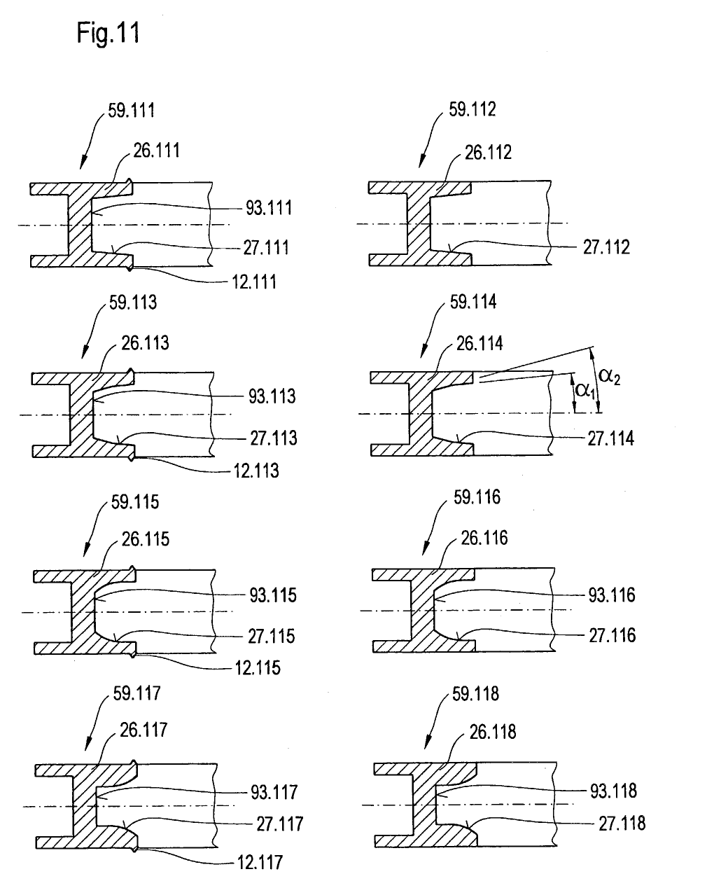

FIG. 12: illustrates potential configurations of the leading surfaces on the stop;

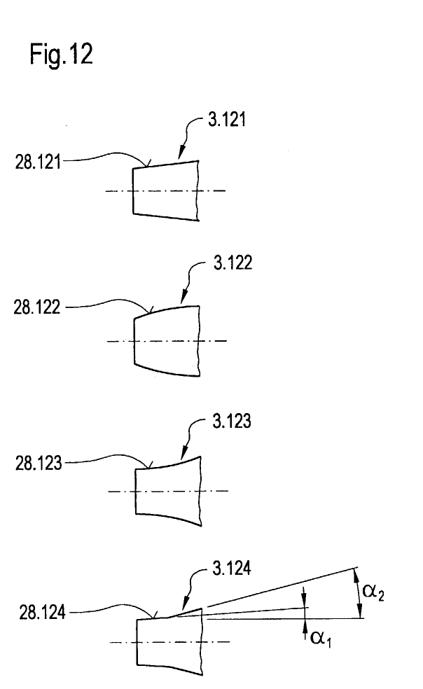

FIG. 13: illustrates by means of a diagram a comparison of the damping effect by means of the torsion angle between a device according to prior art and a device with at least one modification of the invention;

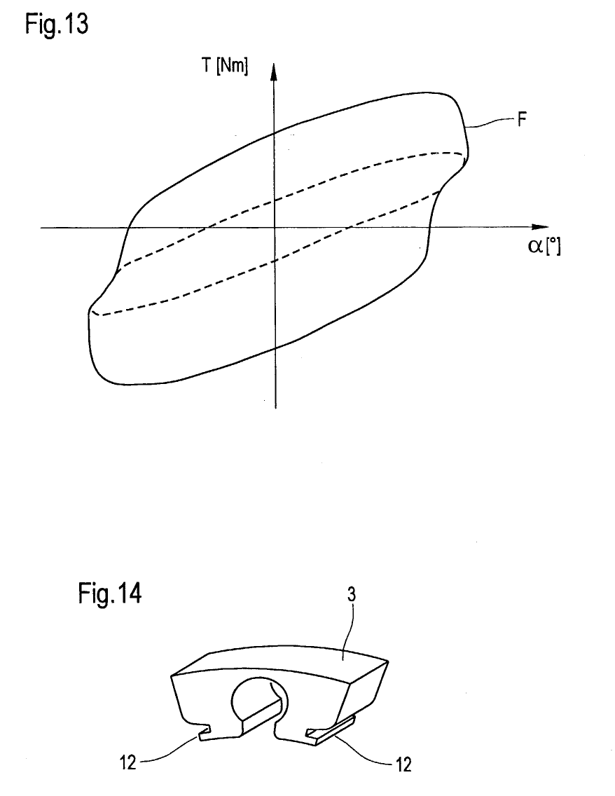

FIG. 14: shows another configuration of a stop element;

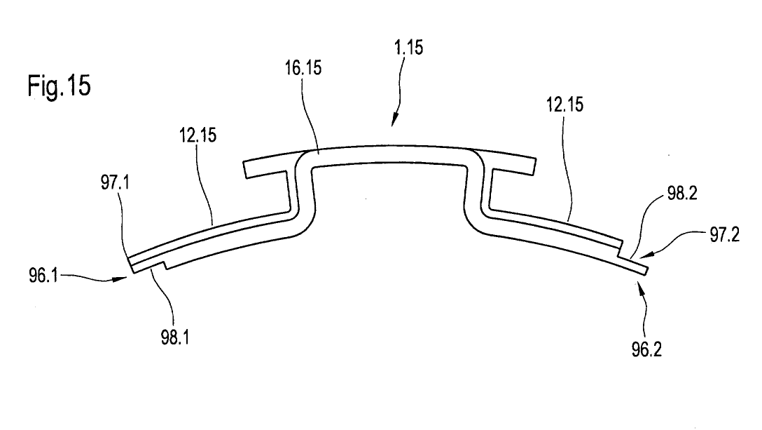

FIG. 15: illustrates an alternative configuration of a ring segment;

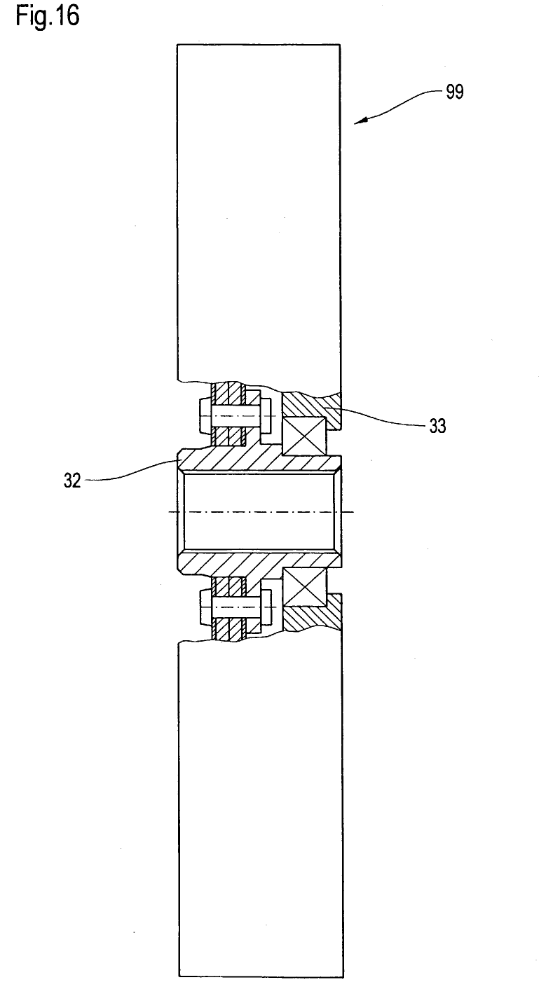

FIG. 16: illustrates the utilization in a quencher.

FIGS. 2a to 2d illustrate in a schematically simplified representation the basic structure and the basic problem of the inferior damping properties by means of two embodiments of the device for damping oscillations 30.1 and 30.2 according to prior art. For example, the devices for damping oscillations 30.1 and 30.2 function as resilient couplings 31.1 or 31.2. The function as a quencher is also conceivable. FIG. 2a illustrates a first potential embodiment of the device for damping oscillations 30.1, especially as a resilient coupling

31.1 in a sectional view of a view in assembled position from the left side, i.e. on a plane which can be defined by two vertical lines relative to the axis of rotation. It comprises a primary unit 32 and a secondary unit 33 where the primary unit 32 is the first coupling half 34 and the secondary unit 33 is the second coupling half of the resilient coupling 31.1. The configuration of the primary unit 32, or the first coupling half 34 can vary. In the simplest case, it comprises two lateral discs 36 and 37 which are connected in a radial direction in the area of their outer circumference and which form a fluid-tight inner chamber 38. In the fluid-tight inner chamber 38, the second coupling half 35 is disposed. It can be configured as a central disc 39, for example, which usually has a hub 40. The torque transmission between the primary unit 32 and the secondary unit 33, or the first coupling half 34 and the second coupling half 35, respectively, takes place via a spring coupling 41 comprising a plurality of tangentially disposed springs 42 inserted in respective cut-outs 43 in the central disc 39 or the lateral discs 36 and 37. Between the outer circumference 44 of the central disc 39 and the radially outer circumference of the inner chamber 38, there is a suspended damping ring 45 in the form of a ring-shaped unit 86. In the illustrated case, according to a first embodiment, said unit is configured as one part in the circumferential direction. The suspended damping ring 45 is disposed inside the first coupling half 34, i.e. the primary unit 32, so as to rotate and it can be rotated by a restricted amount relative to both the first coupling half 34 and the second coupling half 35, namely the central disc 39. However, it is not connected in a direct form-locking manner to either of the two coupling halves 34 and 35. The suspended damping ring 45 forms a radially outside lying first damping or displacement chamber 46 with the first coupling half 34, i.e. the primary unit, and a second damping or displacement chamber 47 with the second coupling half 35, i.e. the central disc 39. To this aim, the suspended damping ring 45 has a several cams 49 on the outer circumference 48. Together with stop elements 3 forming at least one stop 87, configured as pins 51 in the present case, said cams divide the first damping or displacement chambers 46 into two partial damping chambers 13 and 14 between the two lateral discs 36 and 37.

In order to form the second displacement chamber 47, the suspended damping ring 45 is provided with radially inward pointing projections 52 dipping into corresponding indentations or recesses 53 in the central disc 39 that co-forms the secondary unit 33. In the present case, the two damping or displacement chambers, the first damping chamber 46 and the second damping chamber 47, vary in size. The displacement of damping medium in the second damping chamber 47 takes place via the gap 54 between the suspended damping ring 45 and the recesses 53 in the second coupling half 35 forming the secondary unit 33 and which is configured as a central disc 39. The first damping or displacement chamber 46 extends across a large torsion angle between the cams 49, the partial damping chambers 13 and 14 between the cams 49 and the stop 3, and in overcoming said angle the suspended damping ring 45 has to displace the damping medium in the inner chamber 38 through a gap 55 between the stop 3 and the suspended damping ring 45. The gaps 54 and 55 then act as throttle gaps 56 or 57. For example, the throttle gap 56 can be realized via a radial gap 7 between the stop 3 and the outside circumference 92 of the ring-shaped unit 86, i.e. the damping ring 45. The suspended damping ring 45 shown in FIG. 2a is configured such that viewed in the circumferential direction, it is provided with a plurality of such first and second displacement chambers 46 and 47. The following embodiments always relate to a first and a second displacement chamber 46 and 47. In said embodiment, the suspended damping ring 45 is configured as one part in the circumferential direction and because of its particular geometry, it forms said limiting walls for the displacement chambers 46 and 47. The first damping or displacement chambers 46 are then delimited by the end faces 88 and 89 facing each other in the circumferential direction of two cams 49, which are adjacent in the circumferential direction, and the outside surface 67 of the damping ring 45 oriented toward the radially inward pointing inside wall 73 of the primary unit 32 in the area between the two cams 49.

Each of the second displacement chambers 47 is delimited by the outer circumference 44 of the secondary unit 33 and the inner circumference 90 of the damping ring 45. The two damping or displacement chambers 46 and 47 are used for different amplitudes of oscillation. For example, the torsion angle of the suspended damping ring 45 can be much larger inside the first displacement chambers 46 than in the second displacement chambers 47. At the same time, the gaps inside the first displacement chambers 46 are clearly narrower in a radial direction than the gaps in the second displacement chambers 47. In this manner, the two displacement chambers can be associated with varying damping properties. In this case, the second displacement chambers 47 can be responsible for damping the oscillations of small amplitudes and produce only a weak damping because of the large radial and axial gaps. Because of the narrow gaps in the first displacement chambers 46, however, the suspended damping ring 45 is then associated with the oscillations in the first coupling half, the primary unit 32, because the first displacement chambers 46 offer a comparatively high torsional resistance relative to the suspended damping ring 45. Therefore, for oscillations of small amplitudes and especially of higher frequency, the second displacement chambers 47 are primarily active. For oscillations of higher amplitudes, especially when passing critical speeds, the torsion angle inside the second displacement chamber 47 is overcome immediately so that the elements forming the stop surfaces 53 come to rest on the central disc 39 and therefore the suspended damping ring 45 is pulled along by the central disc 39. In this manner, the damping medium is displaced through the gaps in the first displacement chambers 46 causing strong damping for oscillations of high amplitudes. Because of the alternating association of the suspended damping ring 45 to one of the two coupling halves, depending on whether the amplitudes of oscillation are low or high,

the damping can be tailored to the respective form of oscillation.

In contrast, FIG. 2 illustrates an embodiment of a device for damping oscillations 30.2, which is useable as a resilient coupling 31.2 by means of coupling the secondary unit 33 with a rotating element of the drive train. This embodiment can also be used as a quencher when the secondary unit 33 is not connected so as to be rotation-proof. This substantially corresponds to the basic structure and the basic function of the embodiment described under FIG. 2a. However, the suspended damping ring 45.2 in the form of a ring-shaped unit 86.2 consists of a plurality of ring segments 1.1 to 1.n disposed in the circumferential direction, which are not connected. Said ring segments are configured such that they are substantially U-shaped in cross-section as shown in FIG. 2b in a sectional plane which can be defined by two vertical lines relative to the axis of rotation. According to said embodiment, the central disc 39, defined by 23 in the present case, is provided with cams 24 oriented in a radial direction toward the first coupling half 34. The U-shaped contour of the ring segments 1.1 to 1.n delimits a first damping or displacement chamber 46 with the two legs 59 and 60 configured as cams, in this case identified representatively only for segment 1.n, and the connector 61 as well as the stop 3 and the primary unit 32 or the first coupling element 34, respectively, especially the surface 66 facing the inside chamber. The radially inward pointing surface, which in assembled position is identified as the inside surface 67 of the ring segment 1.n, and the cams 24 delimit a second damping and displacement chamber 47. The two chambers are active at different amplitudes of oscillation. In this respect, please see the explanations under FIG. 2a.

By means of a schematically highly simplified view A-A according to FIGS. 2a and 2b, FIG. 2c illustrates the positional allocation between the primary unit 32 and the secondary unit 34 and the ring-shaped unit 86,

the suspended damping ring 45 or a ring segment 1 in unloaded condition.

Said sectional view applies to both cases. The primary unit 32, which is also called the first coupling half 34, can then consist of several lateral discs 36 and 37, which are additionally coupled to a housing or as in the present case, forming the housing 4 or the housing cover 4 itself. During operation, when the inner chamber 38 is filled with a damping medium and the damping chambers, i.e. the displacement chambers 46 and 47, a plurality of each of which is provided in the circumferential direction, are filled with a damping medium, the ring-shaped unit 86, especially the damping ring 45 or the ring segment 1 and the primary unit 32 form a labyrinth seal 2. Said labyrinth seal 2 is disposed radially inside and forms in an axial and radial direction a contactless seal for the damping medium. Said known embodiment is advantageous in that the components can be very simple, while the minimum gap width is always maintained because of production-specific tolerances. More particularly, the sealing gaps 9 and 10 are formed by recesses in the primary unit 32 or the housing or cover 4, respectively, and projections 68, for example in the form of a so-called guide rail 69 or 70 disposed on both sides of the damping ring 45 or the ring segment 1 in an axial direction. The sealing surfaces of the labyrinth seal 2 are then formed by the guide rails 69 and 70 or the recesses 71 and 72 in the housing 4 or the primary unit 32. Moreover, the ring segment 1 or the complete suspended damping ring 45 forms an axial gap 5 with the inside housing wall 73. Such a gap 5 is provided on both sides of the damping ring 45 or the ring segment 1 in an axial direction, but both are identified by the same reference number. Another axial gap 6 is formed on both sides of the ring-shaped unit 86 between the element forming a stop 87, hereinafter simply called stop 3, and the inside housing wall 73 or the inside wall of the primary unit 32. Also, in unloaded condition as shown in FIG. 2c, a radial gap 8 is provided between the ring segment 1 or the damping ring 45 and the inside wall 73 of the housing or the cover 4 or the primary unit 32, especially the surface 66 of the inside wall 73 pointing radially to the inside.

Another radial gap 7 is provided between the suspended damping ring 45 or a ring segment 1 of the suspended damping ring 45 and the stop 3.

During damping, i.e. when the device 30 is in operation, the damping medium pushes the damping ring 45 or the individual ring segments 1 inward in a radial direction so that the gaps 9 and 10, which are virtually in the center in unloaded condition, will change. Under pressure load by means of damping, the gap 10 then becomes virtually zero, i.e. the guide rails 69 and 70 on the segment 1 or the suspended damping ring 45 rest inside the recess 71 or 72 as seen in a radial direction according to the illustration in FIG. 2d. The radial gap 7 between the suspended damping ring 45 and the stop 3 increases. The same applies to the radial gaps 9 between the ring segment 1 or the suspended damping ring 45 and the primary unit 32, i.e. the part forming the housing or the cover 4 of the primary unit 32 of the labyrinth seals 2 radially above the guide rails 69 and 70 of the ring segment 1 or the suspended damping ring 45. The gap dimension of the radial gap 7 changes to the same degree because the stop 3 is disposed so as to be stationary in the housing or the cover 4 and therefore on the primary unit. The damping medium is then usually exchanged via said gap. With oils of low viscosity, especially the so-called ATF oils with a kinematic viscosity in the range from including 10 to 70 cSt, preferably from including 40 to 60 cSt, however, it is frequently not possible, to close the labyrinth gap 10 so that the oil escapes not only in a radial direction via the radial gaps 11 between the primary unit 32 and the damping ring 45 or the ring segment 1 according to FIG. 2e, but also in an axial direction. The available damping volume can then no longer be fully utilized.

FIG. 2e illustrates for a ring segment 1.n according to FIG. 2b the condition in relation to the displacement chamber 46 with regard to the tightness relative to the remaining inside chamber 38 in loaded condition. It shows that the radial gap 11 between the segment 1.n and the housing or cover 4 of the primary unit 32 forming the first coupling half 34 increases. The two legs 59 and 60 can then also be called segment cams which delimit in a radial direction the gap 11 between the ring segment 1.n and the inside housing wall 73.

The primary unit 32 in FIGS. 2a to 2e can be configured any way. It can form a housing or a cover 4 or comprise said cover as a component. Furthermore, the damping chambers can be delimited in an axial direction by means of discs, which are encompassed axially and radially by a housing 4 and/or the cover. Said discs are also a component of the primary unit 32.

In FIGS. 2a to 2e, the definitions primary unit and secondary unit are chosen with regard to the function of the individual elements in the usually illustrated assembled situation with torque transmission via the device for damping oscillations. The definitions primary unit and secondary unit have no relevance with regard to the functional assignment because the components forming them can also be associated with the other unit. In traction operation, for example, the power is transferred to the secondary unit via the primary unit coupled with a driving engine so as to be rotation-proof, while in pushing operation, the power is transferred from the secondary unit to the primary unit. Theoretically, there is also an option to couple the primary unit 32 in the embodiments shown in FIGS. 2a and 2b with the output drive while the secondary unit 33 with the central disc 39 is connected to the driving engine so as to be rotation-proof. Therefore, in this respect, there is no significance with regard to the association of the terms. The functions of both are interchangeable and it is also irrelevant how the connection in the drive train is achieved between the

driving engine and one of the two elements of the device for damping oscillations and the output drive and the other element of the device for damping oscillations.

In order to solve the problem, means 74 are provided for at least partially axially and radially sealing the first damping or displacement chambers 46 against the remaining housing interior 38. According to an especially advantageous embodiment, these are provided on the ring segment 1 according to FIG. 1. FIG. 1a illustrates schematically simplified by means of a section of a profile of a device for damping oscillations 30 on a plane which can be defined by two vertical lines relative to the axis of rotation, where the first vertical line is oriented in horizontal direction and the second vertical line is oriented in vertical direction, the basic structure of a ring segment 1 with means 74 configured in accordance with the invention for at least partially axially and radially sealing one of the first displacement chambers 46. They comprise at least one dynamic contact seal 91. In the illustrated case, said seal is formed by an at least partially continuous flexible sealing lip 12 on the ring segment 1. It is disposed on the outside circumference 92 of the ring segment 1 as seen in assembled position. FIG. 1b illustrates the view A-A according to FIG. 1a of the ring segment 1 and shows that the sealing lip 12 is fully continuous on the surface, i.e. the outside circumference 92. It continues from the partial surface of the outside circumference 92 formed by the cam 59 in a radial direction on the cam or the leg 59, especially the end face 75 formed by said leg in the circumferential direction via the connector 61 to the leg or cam 60, on the end face 76 formed by said leg via the partial surface of the outside circumference 92 formed by said leg in a radial direction and back on the end face 76 in a radial direction inward along the connector 61 and via the end face 75 formed in the circumferential direction on the cam 59 back to the partial surface of the outside circumference 92 pointing outward in a radial direction.

In contrast, FIG. 1c illustrates an embodiment with a continuous sealing lip 12 on the axial end faces 77 and 78 of the ring-shaped unit 86, in the present case a ring segment 1 according to FIG. 1a. The sealing lip is guided on the end face 77 in the circumferential direction via the connector 61 and in a radial direction outward to the partial surface of the outside circumference 92 formed by the cam 60 pointing in a radial direction, via said partial surface to the end face 78, on said face in a radial direction along the cam 60 inward, via the connector 61 in the circumferential direction to the cam 59, in a radial direction outward to the partial surface of the outside circumference 92 formed by the cam 59 and along said partial surface to the end face 77.

FIGS. 1a to 1c illustrate especially advantageous embodiments where the sealing lip 12 is configured such that it is fully continuous around the ring segment 1. The sealing lip is flexible so that it can close in an axial and a radial direction the gaps mentioned under FIG. 2c for the passage of damping medium, especially the gap widths of the axial gap 5 between the ring segment 1 and the housing or cover 4 or the primary unit 32, the radial gap between the ring segment 1 and the housing or cover 4 or the primary unit in the labyrinth seal radially above the guide rail 69 or 70 of the ring segment 1, the radial gap 10 between the ring segment 1 and the housing or cover 4 in the labyrinth seal 2 radially below the guide rail 69 and 70 of the ring segment 1, and the radial gap between the ring segment 1, especially the ring segment leg or cam 59 or 60, and the housing or cover 4 or the primary unit 32. In this manner, the hydraulic damping in the throttle gap 56, i.e. in the radial gap 7 between the ring segment 1 and the stop 3 increases. According to said solution, it is also possible to compensate production tolerances which are of critical importance for said gap sizes. The damping medium can then flow from one to the other partial damping chamber 13 or 14 only, which are a component of the first damping or displacement chambers 48, via the throttle gap 56 configured as a radial gap 7 between the ring segment 1 and the stop 3.

The embodiments shown in FIGS. 1a to 1c can also be applied to a damping ring 45 according to FIG. 2a. In this case, a lip seal 12 is associated with each of the surfaces delimiting a first damping or displacement chamber 46. This applies to the end faces 66 and 89 on the cams 49 and the outside circumference 92 of the damping ring 45.

Furthermore, the sealing lip 12 shown in FIGS. 1a to 1c can also be discontinuous. Another option is combining a plurality of sealing lips 12 which in their entirety form the dynamic contact sealing device 91.

The sealing lip 12 and the ring segment or the damping ring 45, respectively, form a structural unit. Based on the choice of material it can be shaped on during production. In this case, both elements consist of one material, preferably plastic. However, a form-locking or force-locking connection between the sealing lip 12 and the ring segment 1 or the damping ring 45 is also feasible.

FIG. 3 illustrates another configuration of the means 74.3 for at least partially axially and radially sealing the displacement chamber 46.3 by means of a dynamic contact seal 91.3. In this case, a flexible sealing lip 12.3 is also provided, but it is not provided directly on the ring-shaped unit 86.3, i.e. on the ring segment 1.3 or the elements delimiting a first displacement chamber 46.3 on the suspended damping ring 45.3. It is disposed on bridges 15.31 and 15.32 fully or partially radially encompassing the damping chamber, i.e. a first displacement chamber 46.3. The bridges 15.31 and 15.32 are so flexible that under pressure load they rest axially outside against the outside disc or the housing or cover 4.3 of the primary unit 32.3 so as to increase the sealing effect of the sealing lip 12.31 and 12.32 mounted on the flexible bridges 15.31 and 15.32. The contour of the stop 3.3 in an axial direction must then be adjusted accordingly.

The configuration of the bridges 15.31 and 15.32 shown in FIG. 3a only partially encompasses the damping chamber 46.3 in a radial direction. The bridges 15.31 and 15.32 are disposed above the guide rails 69.3 and 70.3 and extend in a radial direction in the direction to the inside wall 73.3 of the primary unit 32.3. The bridges 15.31 and 15.32 are preferably shaped on the ring segment 1.3 or when configured accordingly, to the damping ring 45.3. Theoretically, a separate mounting would also be feasible, but it is not provided because of the high production costs.

FIG. 3b illustrates a section A-A according to FIG. 3a where the axial end face 77.3 is shown. Also shown is the sealing lip 12.31 on the bridge 15.31. The gap 7.3 between the stop 3.3 and the ring segment 1.3, or in the case of a one-part configuration, the suspended damping ring 45.3 is maintained. The bridge 15.31 or 15.32 extends along the axial end face 77.3 or 78.3, in the present case to the partial surfaces of the outside circumference 92 of the ring segment 1.3 formed by the cams 59.3 and 60.3 or the damping ring 45.3. In this case, the axial gaps 6.3 between the stop 3.3 and the primary unit 32.3, the radial gaps 9.3 and 10.3 of the labyrinth seal are largely closed against escaping damping medium. The radial gap 11 remains between the segment cams 59.3 and 60.3 and the primary unit 32.3. It can also be closed by taking additional steps. However, even with said not fully sealed embodiment the damping effect can be improved with oil of low viscosity.

In addition to the choice of material, the flexibility of the individual bridges 15.31 and 15.32 can also be determined by the respective geometry, in the present case especially by the very small width of the bridge 15.31, 15.32 in an axial direction compared to the width of the ring segment 1.3 and/or by the very low width-to-length ratio. The decision for the actual configuration can be made by the responsible person skilled in the art.

FIGS. 4a and 4b illustrate each by means of a section of an axial profile of a device of the invention 30.4 or 30.4b configured as a resilient coupling 31.4a and 31.4b two additional embodiments of the sealing lips 12 of a dynamic contact sealing unit 91 for sealing the first displacement chamber 46.4a. Both embodiments include the option of providing a sealing lip 12.4 on the ring segment 1.4, where the sealing lip 12.4a is disposed directly on the ring segment 1.4a, as shown in FIGS. 1b and 1c, while in the arrangement according to FIG. 4b, a bridge 15.4b is disposed on the ring segment 1.4b similar to the embodiment according to FIGS. 3a and 3b. The embodiments according to FIGS. 4a and 4b are characterized in that a stepped damping region can be produced. The damping is then initially weak and only with a larger torsion angle corresponding to a higher amplitude of oscillation the damping becomes strong, because the contact sealing unit 91 is not fully effective until such a condition is reached. To this aim, the sealing lip 12.4a or 12.4b according to the embodiment shown in FIGS. 1a and 3a is shifted to the edge area of the displacement chambers 46 in the circumferential direction, i.e. to the area of the ring segment cams 59.4a, 59.4b or 60.4a and 60.4b. The central region on the connector 61.4a or 61.4b in unloaded condition is free of any seal. This results in a seal both in an axial and a radial direction with a larger torsion angle of the displacement chambers 46.4a, 46.4b, therefore and especially the displacement chambers 13.3a, 13.3b and 14.3a, 14.3b delimited by the ring segment cams 59.4a, 59.4b and 60.4a, 60.4b and the stop 3.4a, 3.4b. The discontinuous line reflects the course of the contour of the ring segment 1.4b between the bridges 15.4b.

The embodiments and arrangements of the dynamic contact sealing devices 91 shown in FIGS. 1, 3 and 4 are explained especially by means of a ring segment 1. Said segment forms the limiting walls for the first damping and displacement chambers 46, but only partially for the second,

because a cooperation of the cams and the cams of the ring segment disposed adjacent in the circumferential direction is then required. All statements apply accordingly to a ring-shaped unit 86 in the form of a one-part damping ring 46 for a theoretically formed segment from the areas of the damping ring 45 delimiting the damping and displacement chambers 46, especially the cams 49 forming the end faces 88 and 89.

According to a second approach, a higher damping effect can also be achieved solely by providing a corresponding seal between the two partial damping chambers 13 and 14 in that a dynamic contact seal 91 is provided on the stop 3. A combination of the options according to FIGS. 1, 3 and 4 is also possible.

FIGS. 5a and 5b illustrate configurations of the stops 3.5a and 3.5b according to prior art. The stop 3.5a is configured as one part. It is held so as to be stationary on a disc, the housing or the cover 4 by means of fastening elements, usually a pin, a bushing, a screw connection or a riveted connection. The fastening element is identified by 17. The two surfaces 80 and 81 oriented in the circumferential direction form the stop surfaces for the legs 59 and 60 or the cams of the ring segments 1 or the cams 49 of the suspended damping ring 45. FIG. 5b illustrates a stop 3.5b in a multi-part configuration comprising a first partial element 82 which is usually fastened so as to be stationary on a disc, the housing or the cover 4 of the primary unit 32. The second partial element 83 is coupled with the first partial element 82 via a spring device 19 and is configured as a stop spring plate 18. The spring device 19 consists of profiled wire with a round, oval, wedge-shaped or rectangular cross-section or it comprises disk springs. The stop spring plate 18 is then provided in a form-locking manner in the disc, the housing or the cover 4 of the primary unit 32.

According to an especially advantageous embodiment of the invention, the stops shown in FIG. 5a or 5b can be configured with a fully or partially continuous sealing lip 12. FIG. 6a illustrates a configuration with a fully or partially continuous sealing lip 12.6a on a stop 3.6a according to FIG. 5a. Based on the choice of material for the stop 3.6a, the sealing lip 12.6 can be directly shaped on the stop 3.6a. In this case, the stop 3.6a and the sealing lip form a unit and/or they form an integral component. In this case, plastic is the preferred material. Another potential configuration is producing the sealing lip 12.6a as a separate element and connecting it in a form-locking manner with the stop 3.6a.

FIG. 6a also illustrates a configuration with a fully continuous sealing lip. This means that the sealing lip is disposed on the outside circumference 84 and, as seen in an axial direction, in assembled position, it extends over the circumference of the stop 3.6a. Such a continuous configuration achieves a seal in a radial and in the circumferential direction.

In contrast, FIG. 6b illustrates a configuration of a stop according to FIG. 5b identified by 3.6b in the present case. The fully or partially continuous sealing lip 12.6b can be disposed on the partial element 82.6b which is mounted so as to be stationary in the housing while the stop spring plate 18 in the form of a second partial element 83 is disposed via the compression spring device 19 and a guide on a lateral disc, in the housing or the cover 4 of the primary unit 32 as seen in the circumferential direction. Another option (not illustrated) is to provide the continuous sealing lip 12.6b on the stop spring plate 18. In said latter configuration, the sealing lip 12.6b is also preferably shaped on the partial element 82 or 83. A form closure with identical or different materials is also possible.

FIGS. 7a and 7b illustrate modifications of FIGS. 6a and 6b, where each sealing lip 12.7 is realized by means of a seal inserted between individual parts of the stop 3.7.

In this case, the stop consists of at least two parts. In the configuration according to FIG. 7a, the stop 3.7a comprises the two parts 20 and 21 where the sealing lip 12.7a consists of a sealing component 22, in the present case having the form of a sealing profile 22 with rectangular cross-section, as shown in a view from the left side. The sealing profile 22 can be configured as a solid profile or as a hollow profile. In the latter case, the inside dimensions of the hollow profile have to be smaller than the outside dimensions of the stop 3.7a on the plane of connection of the two parts 20 and 21. The two parts 20 and 21 are coupled in a form-locking or preferably a force-locking manner. Therefore, both parts 20 and 21 can be braced relative to each other in the circumferential direction.

In FIG. 7b, the sealing lip 12.7b is disposed between the stop 3.7b and the stop spring plate 18 and it is also formed by a sealing profile 22, which can be a solid profile or a hollow profile. In this case, the first partial element 82.7b consists of at least two parts 20 and 21. Both parts are braced in the circumferential direction via fastening means (not illustrated).

According to a refinement in FIG. 7c, the seal, especially the sealing profile 22, is disposed between the stationary partial element 82.7c of the stop 3.7c and the second partial element 83 in the form of the stop spring plate 18, which is movable relative to the primary unit 32. The seal is disposed on the end face 85 of the first partial element 82.7c which in the circumferential direction is facing the stop spring plate 18. An alternative arrangement on the end face 93 facing the first stationary partial element 82.7c on the second partial element 83.7c in the form of the stop spring plate 18 which is mounted so as to be movable in the circumferential direction is also conceivable.

FIG. 14 illustrates an especially advantageous embodiment of a stop 3. A sealing lip 12 spreading open under pressure is shaped on the stop and the sides and surfaces of the stop fit tightly axially and radially on top.

FIG. 8 illustrates another advantageous embodiment of the inventive solution by means of a section in a top view of a ring segment 1. FIG. 8a illustrates a configuration of a ring segment 1.8a with a continuous seal 12.8a, such as described under FIG. 1, for example. The arrangement on the axial end face 77.8a or 78.8a is shown. Also shown are the configurations of the cams 59.8a and 60.8a of a ring segment 1.8a in the circumferential direction. According to this view, they are preferably U-shaped in cross-section and encompass the central disc 23 of the secondary unit 33.8a. It is also shown that the ring segment cams, i.e. the two legs 59.8a and 60.8a, are parallel with the pulling cam 24 of the central disc 23. An additional sealing effect can now be achieved according to the invention in that at least one cam surface 58 is wedge-shaped because in the final stop position of the ring segment 1 or the corresponding leg 59.8a or 60.8a, the pulling cam 24 of the central disc 23 rests against the ring segment cam 59.8a or 60.8a at the same time. If one of the two cam surfaces, for example a surface 58 of the cam formed in an axial direction is wedge-shaped in accordance with FIG. 7b the sealing surfaces of the ring segment 1.8b are pushed against the housing or cover contour 4.8b in the area of the ring segment cam 59.8b, thereby increasing the hydraulic sealing effect. FIG. 8b illustrates the non-spread condition in which the ring segment 1.8b or the suspended damping ring 45.8b is not activated by the pulling cam 24 on the second coupling element 34.8b or the central disc 23. The wedge-shaped configuration of the axially oriented surface 58 is characterized by the angle a relative to the axis of symmetry of the cam. In contrast, FIG. 8c illustrates the spread condition characterized by the angle β. The surface regions on the cam 59.8b or 60.8b on the ring segment 1.8b oriented in the circumferential direction toward the pulling cam 24 on the central disc 23 as a whole are identified by 16.

The surface regions of the surface region 16 oriented in an axial direction are identified by 58.

The following additional configurations of the wedged surfaces or leading surfaces are conceivable for the pulling cam 24 on the central disc, for example:

curved surface in convex or concave form

curved surface

bent surface

arrangement of the non-plane-parallel leading surface on the ring segment 1 and/or pulling cam 24.

FIG. 9 is an exemplary illustration of further modifications of wedge-shaped cam areas on the ring segment 1 encompassing the pulling cam 24 on the central disc 23. FIG. 9 shows the non-spread condition, where the ring segment 1 or the suspended damping ring 45 is not activated by the pulling cam 24 on the second coupling element 34 or the central disc 23. There are no restrictions with regard to the actual configuration of the wedged surface 58. The cam 59.91 can be configured analog the one in FIG. 8b while the sealing lip on the end face 77 is omitted. In this case, the seal is achieved solely by means of the spread cam end area which encompasses the pulling cam 24. The cam 59.92 illustrates a configuration analog to the cam 59.91, but with an additional sealing lip 12.91 on the cam end area. On both cams in the illustrated case, the surface regions oriented in an axial direction of the surface region 16 pointing to the pulling cam 24 are wedge-shaped with a constant wedged surface 58.91 or 58.92.

Cam 59.93 represents a refinement of 59.91 characterized by a discontinuous change in the course of the wedged surface 58.93. Cam 59.94 corresponds to cam 59.93, but without the sealing lip.

Cams 59.95 to 59.98 represent embodiments where the wedged surfaces 58.95 to 58.98 are configured convex or concave. The embodiments are shown with and without a sealing lip 12.

In contrast, FIG. 10 illustrates a simplified representation of exemplary embodiments of the configuration of a pulling cam 24 in a view of the central disc 23, especially the leading surface 25. The pulling cam 24.201 has a bent leading surface 25.101. 24.102 illustrates an embodiment with a constant curved leading surface 25.102. 24.103 is an embodiment with non-constant curvature 25.103 and 24.104 is an embodiment with multiple changes in the course of the surface 25.104. The leading surfaces 25 are formed both by the surfaces pointing to the ring segment in the circumferential direction and by partial regions of adjacent, axially oriented surfaces.

The statements made in relation to FIGS. 3 to 10 also apply accordingly to the cooperation of the cams 59 or 60 and the stop 3 when the volume in the partial damping chambers 13 and 14 is reduced. Consequently, a higher sealing effect can also be achieved in this case in cooperation with the stop 3 in that the surfaces carrying the seal 91 or individual regions on the segment are configured accordingly. According to FIG. 11, an additional sealing effect can be achieved by providing the cams 59 and 60 in the area of the end faces 75 and 76 facing each other with projections 26 oriented in the circumferential direction whose facing regions 29 carrying the surfaces 27 are wedge-shaped. If one of the two cam surfaces, for example an axially oriented surface 27 of the cam 59 is wedge-shaped, the sealing surfaces are formed by the axial end faces 77 and 78 on the cam 59 of the ring segment 1, and in the area of the ring segment cam 59, they are pushed against the housing or cover contour 4 under the effect of the leading surfaces 28 on the stop 3, thereby increasing the hydraulic sealing effect.

For example, the following additional configurations of the wedged surfaces 27 on the ring segment and/or the leading surfaces 28 for the stop 3 are feasible:

continuously tapering configuration

curved surface in convex or concave form

surface curved in any form

bent surface

arrangement of a non-plane-parallel leading surface on the ring segment and/or the stop.

FIG. 11 shows cam configurations in non-spread condition where the ring segment 1 or the suspended damping ring 45 is not activated by the stop 3. There are no restrictions with regard to the actual configuration of the wedged surface 58. The cam 59.111 is provided in an axial direction on both sides with projections 26.111 oriented in the circumferential direction toward the stop. Said projections carry a sealing lip 12.111 as shown with regard to cam 59.111. The axially oriented surface 27.111 of the surface region 93.111 facing the stop 3 is wedge-shaped. The end area of the cam 59.112 corresponds to that of 59.111, but the sealing lip was omitted and the sealing surface is directly formed only by the axial end faces 77 and 78 of the ring segment and/or the damping ring 45.

Cam 59.113 represents a refinement of 59.111 characterized by a non-constant change in the course of the wedged surface 58.113. Cam 59.114 corresponds to cam 59.113, but without the sealing lip.

The cams 59.115 to 59.118 represent embodiments with convex and concave configuration of the wedged surfaces 58.115 to 58.118. The embodiments are shown with and without a sealing lip 12.

FIG. 12 illustrates various embodiments of the stop 3 viewed in cross-section. They are used in combination with embodiments according to FIG. 11 or when the cam areas are configured with plane-parallel surfaces 27 facing each other. In the end area, the stop 3.121 has a constantly decreasing cross-section so that the leading surface 28.121 is wedge-shaped. The stops 3.122 and 3.123 illustrate configurations with a constantly curving leading surface 28.122, 28.123 which can be convex or concave. 3.124 illustrates a configuration of the leading surface 28.124 with sudden changes in the course of the surface. The leading surfaces 28 are then formed both by the surfaces pointing to the ring segment in the circumferential direction and by partial regions of adjacent and axially oriented surfaces.

FIG. 13 shows a comparison by means of a diagram of the damping effect via the torsion angle using a device according to prior art (discontinuous line) and a device with at least one modification of the invention (continuous line). The free lift area F is also shown.

Generally, the sealing lips can consist of the same material as the stop or the ring segment and they can be made so as to form one part with said segment. However, it is also possible to make the sealing lip of a flexible material in a form-locking manner as one part with the basic material of the ring segment or to connect it with said segment.

FIG. 15 illustrates an alternative geometric configuration of a ring segment 1.15 for an embodiment according to FIGS. 1, 2 and 3. It is generated by a different arrangement of the suspended damping ring in the circumferential direction. The cams 16.15 are disposed in the center of the ring segment. Two ring segments 1.15 disposed adjacent in the circumferential direction delimit a damping chamber, i.e. a first displacement chamber 46.15. The central cam 16.15 as seen in a radial direction forms a recess in which the projection disposed in a radial direction on the secondary unit engages.

With regard to the arrangement of the sealing lip 12.15, reference is made to the embodiments in FIGS. 1, 3 and 4. The sealing lip 12.15 is preferably disposed on the circumference of the ring segment and encompasses the part of the displacement chamber delimited by said ring segment. Only the leading area for the stop on the outside circumference in a radial direction has no sealing lip. In the embodiment shown in FIG. 15, the sealing lips 12.15 either extend on the axial end faces on the outside circumference of the ring segment cam 12.15 in the circumferential direction and then in a radial direction on the cam 16.15 where, upon reaching the outside circumference in a radial direction the sealing lip 12.15 is guided in an axial direction to the parallel axial end face. Accordingly, the sealing lip 12.15 can also be guided and disposed on the outside circumference first in the circumferential direction, then a radial direction, an axial direction and then in a radial direction and the circumferential direction in the area of the axial end faces 95. With regard to the embodiment and configuration of the sealing lip 12.15, there are also no differences compared to those described for the alternative embodiment of the ring segment.

According to an especially advantageous embodiment, the end regions 96.1, 96.2 of the ring segment 1.15 are configured such that they form a tight connection in a radial direction with the respective adjacent ring segments disposed in the circumferential direction. To this aim, the guides 97.1 and 97.2 are provided in the end regions cooperating with complementary configured guides on the adjacent elements where the cooperation is characterized by overlapping which is maintained even with a minor relative movement between two adjacent ring segments disposed in the circumferential direction. The end regions 96.1 and 96.2 are then tapering, preferably by means of step-like changes in the cross-section in a radial direction. The guide surfaces 98.1 and 98.2 formed in a radial direction by the steps on a ring segment can be oriented in the same or in different directions, as shown in FIG. 15.

They then cooperate with the complementary oriented guide surfaces on the adjacent ring segments.

The embodiment of the ring segment 1.15 shown in FIG. 15 is production-specifically advantageous with regard to its geometry.

Merely as an example, FIG. 16 illustrates another use of the solution of the invention in addition to a device for damping oscillations in the form of a resilient coupling in an oscillation quencher 99 characterized in that said quencher is used solely for quenching oscillations, not for torque transmission. In this case, only one unit, the primary unit 32 or the secondary unit 33 is connected so as to be rotation-proof with the drive train. In the illustrated case, it is the primary unit 32.

Reference List

| | |
|---|---|
| 1 | ring segment |
| 2 | labyrinth seal |
| 3 | stop |
| 4 | housing/cover |
| 5 | axial gap between ring segment and housing/cover |
| 6 | axial gap between stop and housing/cover |
| 7 | radial gap between ring segment and stop |
| 8 | radial gap between stop and housing/cover |
| 9 | radial gap between ring segment and housing/cover in the |
| | labyrinth seal radially above the guide rail of the ring segment |
| 10 | radial gap between ring segment and housing/cover in the |
| | labyrinth seal radially below the guide rail of the ring segment |
| 11 | radial gap between ring segment cam and housing/cover |
| 12 | sealing lip |
| 13, 14 | partial chambers |
| 15 | sealing lip with bridge |
| 16 | ring segment cam |
| 17 | fastening pin, bushing, screw, rivet, plug-in connection |
| 18 | stop spring plate |
| 19 | pressure spring |
| 20, 21 | divided stop |
| 22 | seal |
| 23 | central disc |
| 24 | pulling cam of the central disc |
| 25 | leading surface |
| 26 | projection |
| 27 | surface |
| 28 | leading surface |
| 29 | region |
| 30 | device for damping oscillations |
| 31 | resilient couplings |
| 32 | primary unit |
| 33 | secondary unit |
| 34 | first coupling half |
| 35 | second coupling half |
| 36 | first lateral disc |
| 37 | second lateral disc |
| 38 | fluid-tight inner chamber |
| 39 | central disc |
| 40 | hub |
| 41 | spring coupling |
| 42 | springs |
| 43 | section |
| 44 | outside circumference |
| 45 | suspended damping ring |
| 46 | first displacement chamber |
| 47 | second displacement chamber |
| 48 | outer circumference of the suspended damping ring |
| 49 | cam |
| 50 | pin |
| 51 | pin |
| 52 | projections |
| 53 | recesses |
| 54 | gap |
| 55 | gap |
| 56 | throttle gap |
| 57 | throttle gap |
| 58 | surface |
| 59 | leg, cam |
| 60 | leg, cam |
| 61 | connector |
| 66 | surface |
| 67 | outside surface |
| 68 | projection |
| 69 | guide rail |
| 70 | guide rail |
| 71 | recess |
| 72 | recess |
| 73 | inside housing wall |
| 74 | means for at least axially and radially sealing the partial |
| | chambers 13 and 14 of the first displacement chamber 46 |
| 75 | end face of the leg 59 |
| 76 | end face of the leg 60 |
| 77 | axial end face of the ring segment |
| 78 | axial end face of the ring segment |
| 79 | circumference |
| 80 | surface on the stop oriented in the circumferential direction |
| 81 | surface on the stop oriented in the circumferential direction |
| 82 | partial element |
| 83 | partial element |
| 84 | outside circumference |
| 85 | end face |
| 86 | ring-shaped unit |
| 87 | stop |
| 88 | end face |
| 89 | end face |
| 90 | inner circumference |
| 91 | dynamic contact seal |
| 92 | outside circumference |
| 93 | end face |
| 94 | surface region |
| 95 | axial end face |
| 96 | end region |
| 97 | guide |
| 98 | guide surface |
| 99 | quencher |

1. Device for damping oscillations, especially an oscillation damper;
1.1 having a primary unit and a secondary unit which can be rotated relative to each other in the circumferential direction by a restricted amount;
1.2 the primary unit forms an inner chamber in which the secondary unit is disposed;
1.3 the primary unit and the secondary unit are connected via a spring coupling and a damping coupling;
1.4 the damping coupling comprises at least one damping chamber that can be filled with a damping medium;
1.5 in the inner chamber there is disposed at least one ring-shaped unit which is not connected in a form-locking manner with the primary unit and the secondary unit;
1.6 having a contactless sealing device between the ring-shaped element and the primary unit;
1.7 the ring-shaped unit forms first damping chambers with the primary unit and second damping chambers with the secondary unit; characterized by the following feature:
1.8 having at least one dynamic contact sealing device for at least partially sealing the first damping chambers in an axial and/or radial direction.

2. Device as defined in claim 1, characterized in that the dynamic contact sealing device comprises a flexible lip seal.

3. Device as defined in claim 2, characterized in that the lip seal is resilient.

4. Device as defined in any of the claims 2 or 3, characterized in that the sealing lip of the lip seal and the element of the lip seal carrying the sealing lip are resilient.

5. Device as defined in any of the claims 2 to 4, characterized in that the resilience is determined by the choice of materials.

6. Device as defined in any of the claims 2 to 5, characterized in that the resilience is determined by the geometric contour.

7. Device as defined in any of the claims 1 to 6, characterized by the following features:
7.1 having means for restricting the torsion angle;
7.2 the means for restricting the torsion angle comprise at least one stop which is stationary relative to the primary unit;
7.3 the stop element is disposed in the first damping chamber and divides the damping chamber into two partial damping chambers that are variable in size;

8. Device as defined in claim 7, characterized in that the two partial damping chambers are connected via a radial gap formed between the stop and the outside circumference of the ring-shaped unit.

9. Device as defined in any of the claims 1 to 8, characterized in that the ring-shaped unit is configured as one part in the form of a damping ring.

10. Device as defined in claim 9, characterized in that the ring-shaped element in the circumferential direction is provided with projections pointing to the primary unit in a radial direction, which form the limiting surfaces of the first damping chambers in the circumferential direction.

11. Device as defined in claim 9 or 10, characterized in that in a radial direction the ring-shaped element is provided with projections pointing inward away from the inside circumference, which delimit the second displacement chambers with the outside circumference of the secondary unit.

12. Device as defined in claim 7, characterized by the following features:
12.1 the ring-shaped unit comprises a plurality of ring segments disposed so as to be adjacent in the circumferential direction;
12.2 each ring segment is provided at its ends in the circumferential direction with projections pointing outward in a radial direction delimiting a first displacement chamber in the circumferential direction, and
12.3 in cooperation with an adjacent ring segment in the circumferential direction delimiting the second displacement chamber in a radial direction.

13. Device as defined in any of the claims 7 to 12, characterized in that the dynamic contact sealing device on the damping ring is disposed on the surface regions delimiting the first damping or displacement chamber or on the ring segment.

14. Device as defined in claim 13, characterized in that the contactless sealing device is disposed at least partially continuously on the outside circumference of the ring segment or the damping ring on the radially outward oriented surfaces delimiting the first damping chamber.

15. Device as defined in claim 13, characterized in that the contactless sealing device is disposed at least partially continuously on the axial end faces of the ring segment or the damping ring in the area of the outside circumference of the ring segment or the damping ring and the surface regions on the projections pointing in a radial direction on the outside circumference.

16. Device as defined in any of the claims 13 to 15, characterized in that the dynamic contact sealing device is disposed in the area of the projections and extends only partially in the circumferential direction to the other projection delimiting the first damping chamber.

17. Device as defined in any of the claims 13 or 14, characterized in that the dynamic contact sealing device is disposed so as to be fully continuous.

18. Device as defined in any of the claims 13 to 17, characterized in that the dynamic contact sealing device is formed by the ring segment or the damping ring.

19. Device as defined in any of the claims 13 to 17, characterized in that the dynamic sealing device is formed by separate components and is connected with the ring segment or the damping ring in a form-locking or force-locking manner.

20. Device as defined in claim 19, characterized in that the dynamic contact sealing and the ring segment or the damping ring consist of different materials.

21. Device as defined in any of the claims 13 to 20, characterized in that the dynamic contact sealing device on the axial end faces of the ring segment or the damping ring comprises bridges oriented in a radial direction as sealing lip carriers.

22. Device as defined in claim 21, characterized in that the bridge extends over at least part of the radial dimension of the damping chamber.

23. Device as defined in claim 21 or 22, characterized in that the bridge is shaped on the ring segment or the damping ring.

24. Device as defined in claim 21 or 22, characterized in that the bridge is coupled with the ring segment or the damping ring in a force-locking or form-locking manner.

25. Device as defined in any of the claims 3 to 24, characterized in that the dynamic sealing contact device is disposed on the stop.

26. Device as defined in claim 25, characterized in that the dynamic contact seal extends at least partially over the outside circumference of the stop in an axial and radial direction.

27. Device as defined in claim 25 or 26, characterized by the following features:
27.1 the stop comprises two partial elements, a first partial element mounted so as to be stationary on the primary unit and a second partial element provided in the primary unit so as to be movable in the circumferential direction;
27.2 the dynamic contact seal is disposed on one of the two partial elements.

28. Device as defined in claim 26 or 27, characterized in that the stop or one of the partial elements of the stop consist of multiple parts that are connected in a force-locking or form-locking manner where the sealing device is configured as a sealing profile and is braced between the individual parts.

29. Device as defined in any of the claims 9 to 28, characterized by the following features:
29.1 the projections on the ring segment or the damping ring as seen in cross-section from top in assembled position are provided with two axial projections facing the stop in the circumferential direction;
29.2 the surfaces on the projections provided in an axial direction and facing each other are wedge-shaped.

30. Device as defined in any of the claims 9 to 29, characterized in that the stop in a top view in assembled position in the circumferential direction in cross-section is configured tapering toward the projections on the ring segment and the damping ring, especially wedge-shaped or having multiple steps or concave or convex.

31. Device as defined in any of the claims 1 to 30, characterized by the following features:
31.1 the projections on the ring segment or the damping ring as seen in cross-section from top in assembled position are provided with two axial projections facing the secondary unit in the circumferential direction;
31.2 the surfaces on the projections provided in an axial direction and facing each other are wedge-shaped.

32. Device as defined in any of the claims 1 to 31, characterized in that the projection on the secondary unit in a top view in assembled position in the circumferential direction in cross-section is configured tapering toward the projections on the ring segment and the damping ring, especially wedge-shaped or having multiple steps or concave or convex.

33. Device as defined in any of the claims 1 to 32, characterized in that the primary unit consists of multiple parts.

34. Device as defined in claim 33, characterized in that the primary unit comprises at least a housing encompassing the secondary unit.

35. Device as defined in claim 34, characterized in that the primary unit comprises at least one disc element coupled with the housing.

36. Device as defined in any of the claims 1 to 35, characterized in that the secondary unit comprises at least one central disc which is encompassed by the primary unit in an axial and radial direction.

37. Utilization of a device as defined in any of the claims 1 to 36 as a resilient coupling in a drive train where the primary unit is connected so as to be rotation-proof with a driving engine and the secondary unit is connected so as to be rotation-proof with the output drive and the primary unit forms a first coupling half and the secondary unit forms a second coupling half.

38. Utilization of a device as defined in any of the claims 1 to 36 as a quencher in a drive train where the primary unit is connected so as to be rotation-proof with a driving engine and the secondary unit is not coupled so as to be rotation-proof with a rotating component.

39. Starting unit for the integration in transmission units
39.1 with a hydrodynamic converter or a hydrodynamic coupling and a bridging coupling where the hydrodynamic unit and the bridging coupling are connected in parallel;
39.2 with a device for damping oscillations as defined in any of the claims 1 to 36;
39.3 with a supply system for operating medium and lubricant jointly assigned to the hydrodynamic unit, the bridging coupling and the device for damping oscillations.
